(19) United States
(12) Patent Application Publication
(10) Pub. No.: US 2006/0249878 A1
(43) Pub. Date: Nov. 9, 2006

(54) Wall panels and methods and apparatus for forming wall panels for building applications

(76) Inventor: Hikmet Unsal, Istanbul (TR)

Correspondence Address: NIXON & VANDERHYE, PC, 901 NORTH GLEBE ROAD, 11TH FLOOR, ARLINGTON, VA, 22203, US

(21) Appl. No.: 11/121,941

(22) Filed: May 5, 2005

(51) Int. Cl. B29C 70/44; B29C 33/58

(52) U.S. Cl. 264/258; 264/314; 264/316; 425/417

(57) ABSTRACT

Panels for building construction are formed of industrial or agricultural wastes or environmental materials supplied in layers together with mesh layers in stacked steel molds. Male molds are received in the first molds, each having an inflatable cover about a rigid tube. By pressurizing the volume between the tube and cover the cover is expanded to pressurize the filler material within the mold. Heated liquid is utilized to facilitate hardening of the materials within the mold. Vibration is also applied to the liquid and the molds are rotated about a horizontal axis. The molds are opened and the male molds removed and wall panels with insulated interior passages are provided.

### BACKGROUND OF THE INVENTION

The present invention relates to wall panels and methods and apparatus for fabricating wall panels for use in buildings and particularly relates to wall panels and methods and apparatus for forming building wall panels from waste or recycled materials.

Current building materials are typically fabricated from raw materials, e.g. wood, minerals or chemicals. These materials require substantial engineering efforts and expense to not only process the materials when building new construction but also to break down or dispose of those materials when the building is of no longer any use and requires demolition. Thus, those building materials burden the environment when the building is renovated and/or demolished. While there has been an increasing trend toward use of environmentally friendly building materials, waste material from even those environmentally friendly materials during construction, renovation or demolition are oftentimes not reused. Accordingly, there has developed a need for the fabrication of principal components of a building, e.g. wall panels which may utilize as constituent elements almost any waste material available in the geographic location of the production facility.

In accordance with a preferred embodiment of the present invention, waste materials, e.g., as found in nature and not residual demolished construction material, such as rice shells, tuff, sunflower peduncle, cotton pod peduncle, forest refuse, straw, and other locally available materials may be used in the fabrication of wall panels in conjunction with a suitable binder. Thus these materials may be shredded, i.e., reduced in size for use in the fabrication methods and apparatus hereof for the formation of wall panels that are durable, enduring, inexpensive, have requisite strength characteristics and insulation properties and can be readily and easily applied in construction during hot and cold extreme weather conditions. For example interior wall panels may be formed having wall thicknesses ranging from 10-15 centimeters to 20 centimeters, a width of about 120 centimeters and a length that may vary from 280 centimeters to 300 centimeters. It will be appreciated that the materials forming the wall panels may be cut to fit the required sizes. For exterior walls, similar materials may be utilized with an external layer highly resistant to external environmental elements, such as heat, humidity, temperature variation and which has high heat insulation properties. Likewise floor and ceiling panels may be manufactured to the appropriate size, thickness and strength to carry vertical loads.

In a preferred embodiment of the present invention, there is provided a method of fabricating panels for use in a building comprising the steps of:

(a) providing a first mold having a bottom wall and side walls;

(b) disposing a first layer of a first material within the first mold;

(c) disposing a first layer of mesh material overlying the first layer of material;

(d) disposing a first layer of filler material overlying the first layer of mesh material;

(e) locating a plurality of male molds at spaced locations from one another within the first mold and overlying the first layer of filler material.

(f) disposing a second layer of a filler material within the first mold about said male molds and overlying the first layer of filler material;

(g) disposing a second layer of mesh material overlying the second layer of filler material;

(h) disposing a second layer of a second material within the first mold and overlying the second layer of mesh material;

(i) closing the first mold;

(j) expanding the male molds within the closed first mold to pressurize the first, second and filler materials;

(k) removing the male molds from the first mold; and

(l) removing the panels from the first mold; and

(m) curing the first, second and filler materials.

In another preferred embodiment of the present invention, there is provided a method of fabricating panels for use in a building comprising the steps of:

(a) providing a plurality of molds, each having a bottom wall and side walls;

(b) disposing a first layer of a first material within each mold;

(c) disposing a first layer of mesh material overlying the first layer of material in each mold;

(d) disposing a first layer of filler material overlying the first layer of mesh material in each mold;

(e) locating a plurality of male molds at spaced locations from one another within each mold and overlying the first layer of filler material;

(f) disposing a second layer of a filler material within each mold about said male molds and overlying the first layer of filler material;

(g) disposing a second layer of mesh material overlying the second layer of filler material in each mold;

(h) disposing a second layer of a second material within each mold and overlying the second layer of mesh material;

(i) closing each mold;

(j) stacking the plurality of molds one on top of another;

(k) expanding the male molds within the stacked molds to pressurize the first, second and filler materials in each mold to form the panels in the molds;

(l) removing the male molds from each mold;

(m) removing the panels from each mold; and

(n) curing the first, second and filler materials within each mold.

In still another preferred embodiment of the present invention, there is provided a mold apparatus for forming building panels comprising a first mold having a bottom, sides and a removable top cover defining a mold volume; and a plurality of elongated male molds for disposition within the mold volume and spaced one from the other; each male mold including an elongated rigid tube and an overlying flexible cover, the tube including a fluid inlet for flowing fluid into and within the tube and at least one aperture in communication with a second volume between the cover and tube for flowing fluid from within the tube through the aperture, the tube including an outlet in communication with the second volume for flowing fluid therefrom through the outlet.

It will be appreciated that a wide variety of waste materials may be utilized in the formation of the wall panels in accordance with the preferred embodiment of the present invention. These range from agricultural wastes to industrial wastes, as well as recycled waste material.

### BRIEF DESCRIPTION OF THE DRAWINGS

FIGS. 1A and 1B are perspective views of panels constructed in accordance with the preferred embodiments of the present invention;

FIG. 2 is an exploded perspective view illustrating the various components of a panel between top and bottom molding plates;

FIG. 3 is an enlarged cross-sectional view through the mold illustrating the male mold within the first mold;

FIG. 4 is a diagrammatic illustration of the process for forming the wall panels;

FIG. 5 is a perspective view with parts exploded and broken out for ease of illustration showing the male mold within the panel within the first mold; and

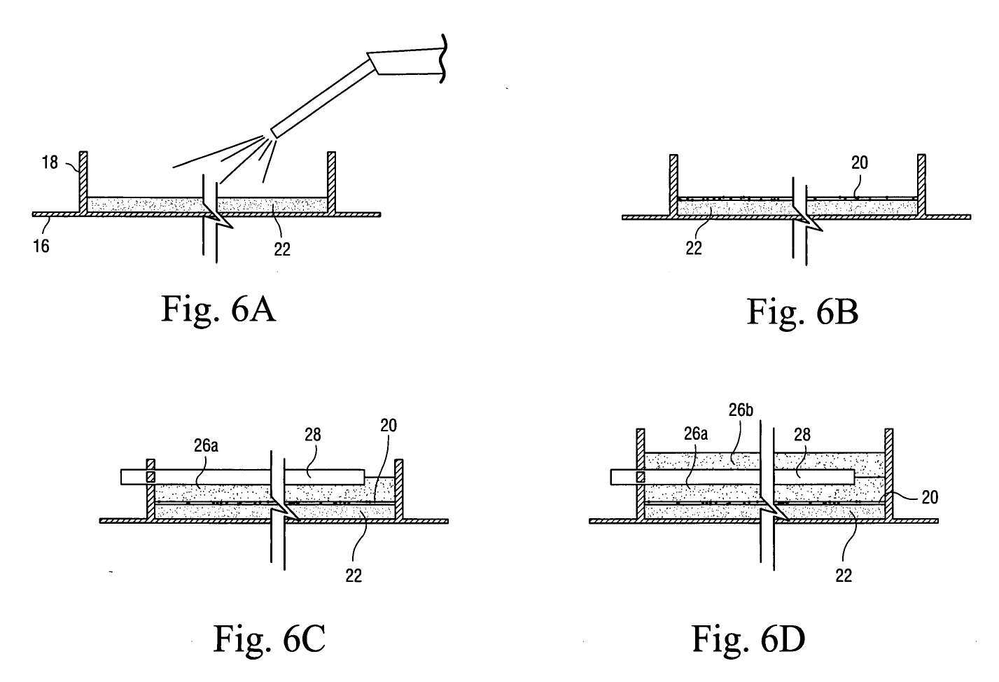

FIGS. 6A-6H are diagrammatic illustrations of the method of forming the wall panel.

### DETAILED DESCRIPTION OF THE INVENTION

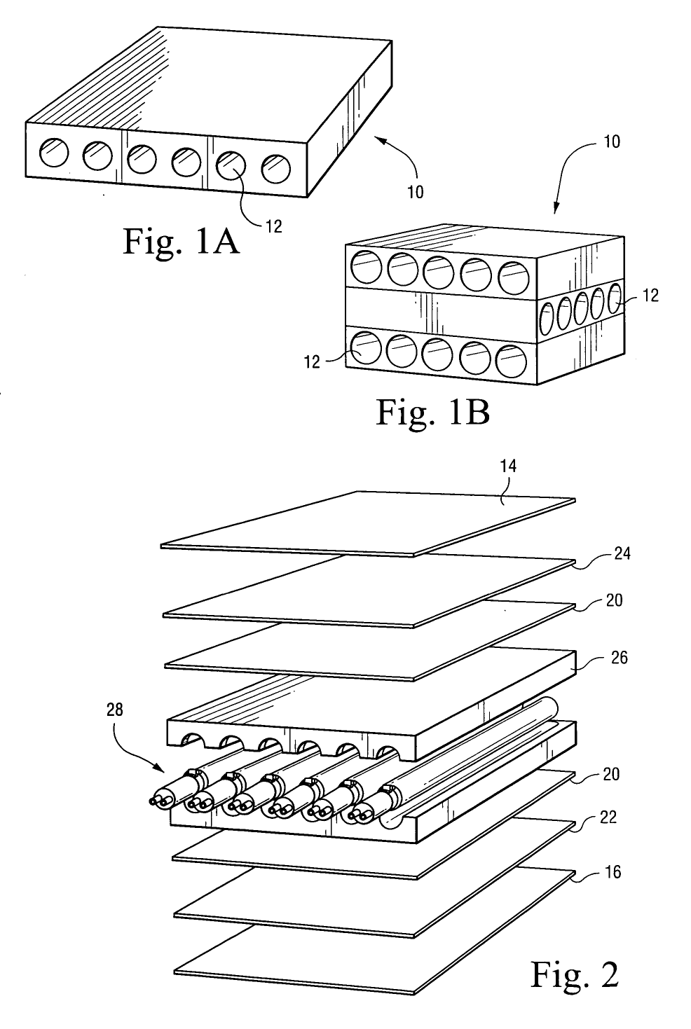

Referring to the drawing figures particularly to FIG. 1, there is illustrated a wall panel constructed in accordance with the preferred embodiment of the present invention. The panel 10 may comprise a wall panel, a ceiling panel or a floor panel. The panel may be fabricated to various sizes. For example a typical interior wall panel may have a wall thickness from 10-20 centimeters, a width of 120 centimeters and a length that may vary from 280 to 300 centimeters. Panels used as exterior walls in building construction must be highly resistant to environmental elements such as heat, humidity, rain and temperature changes with high insulation properties. Thus, as illustrated in FIG. 1A, a plurality of openings 12 extend the length of the panel in a single layer thereof and are provided during fabrication of the panel as set forth below. Alternatively, multiple layers of openings may be provided in a single panel. For example, as illustrated in FIG. 1B, three layers of openings 12 are provided in a single panel with one layer of openings 12 extending 90° relative to one or more adjacent layers of openings. The openings provide for insulation. Where the panels form floor or ceiling units, the size and thickness of the panels can be varied to carry the vertical loads.

The panels may be fabricated from a wide variety of materials varying from waste materials such as agricultural and industrial wastes to naturally-occurring materials such as volcanic tuff. The fabrication of the wall panels preferably occurs near the geographic location of the waste or natural materials to minimize loading and transportation costs from the fabrication site to the building site. Examples of such materials are volcanic tuff mixed with a bonding material such as gypsum, sunflower peduncle mixed with formaldehyde, cotton pod peduncle mixed with a cement, and other filler materials, such as rice shells, straw, forest refuse mixed with a suitable bonding material. It will also be appreciated that difference surface materials may be provided depending upon whether the end use of the panel is an external wall, an internal wall or a floor or ceiling component of the building. For example for an external wall, layers of material may comprise an external surface material, reinforcing mesh, a filling material, a mesh and an inner surface material. For internal wall panels, the materials may comprise an internal surface material, a mesh, a filling material, a mesh and an internal surface material. For floor or ceiling panels, the panel may comprise a flooring or ceiling material, a mesh, a filling material, a mesh and an inner surface material.

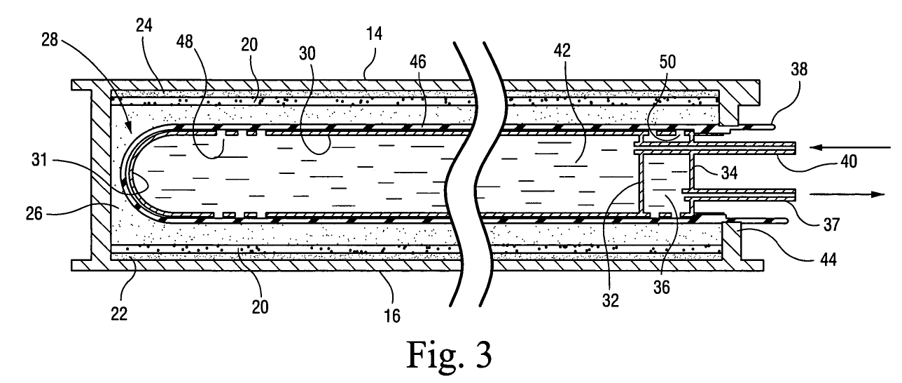

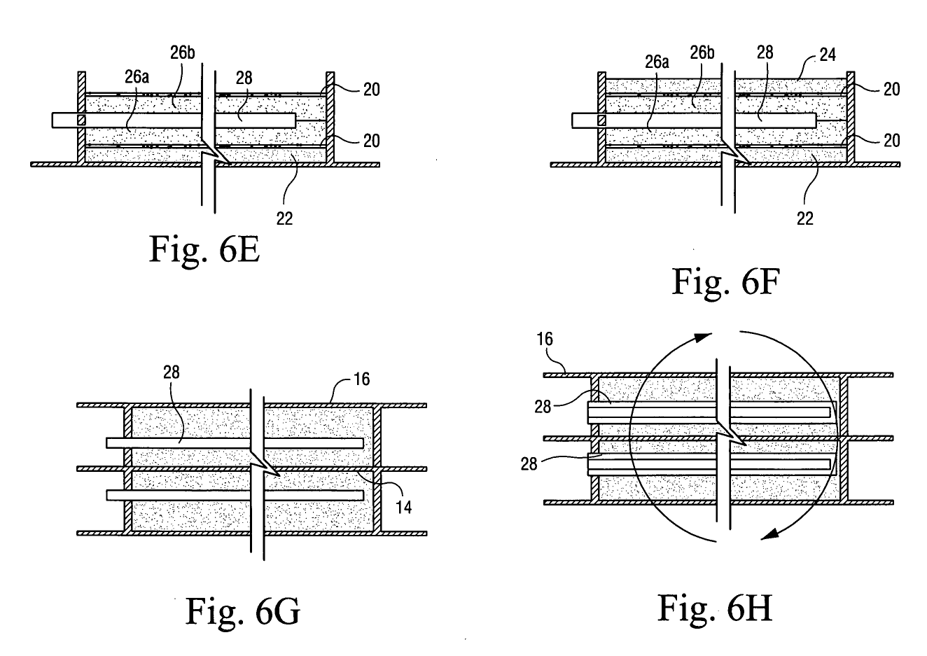

Referring to FIG. 2, there is schematically illustrated a mold having top or cover and bottom mold plates 14 and 16 respectively. The molds are preferably formed of steel with appropriate thickness and having side walls 18 (FIGS. 6A-6H). Preferably the interior surfaces of the steel molds are coated with a non-sticking material, e.g., Teflon® to facilitate removal of the panel from the mold. The panels are also preferably formed with one or more layers of a mesh material as illustrated at 20 in FIG. 2. The reinforcing mesh material may comprise a fiber mesh, a wire mesh or glass fiber mesh or any other type of mesh material which affords appropriate strength and resistance to external loadings.

As will be appreciated, different materials are utilized for the external and internal surfaces of each panel depending on the nature of its use. Thus these different materials are placed inside the mold in sequence as explained below. For example, for an exterior panel having both an interior and external surface, a fine grain material and a filling grain material such as volcanic tuff but utilizing particles of different sizes may be utilized. For example, for volcanic tuff fine grains between 5-1.5 millimeters may be used as a first layer forming an interior surface. For forming the exterior surface, volcanic tuff particles crush to 5-6 millimeters particle size may be utilized each, of course, being mixed with a bonding agent such as cement. Thus as illustrated in FIG. 2 an interior surface material of fine particle size is designated 22 and an exterior panel surface of more coarse particle size is designated 24. Intermediate the exterior and interior surface materials is a filler material 26 which may comprise a similar material of the same or different particle size as the exterior or interior surface materials or may comprise a different material entirely.

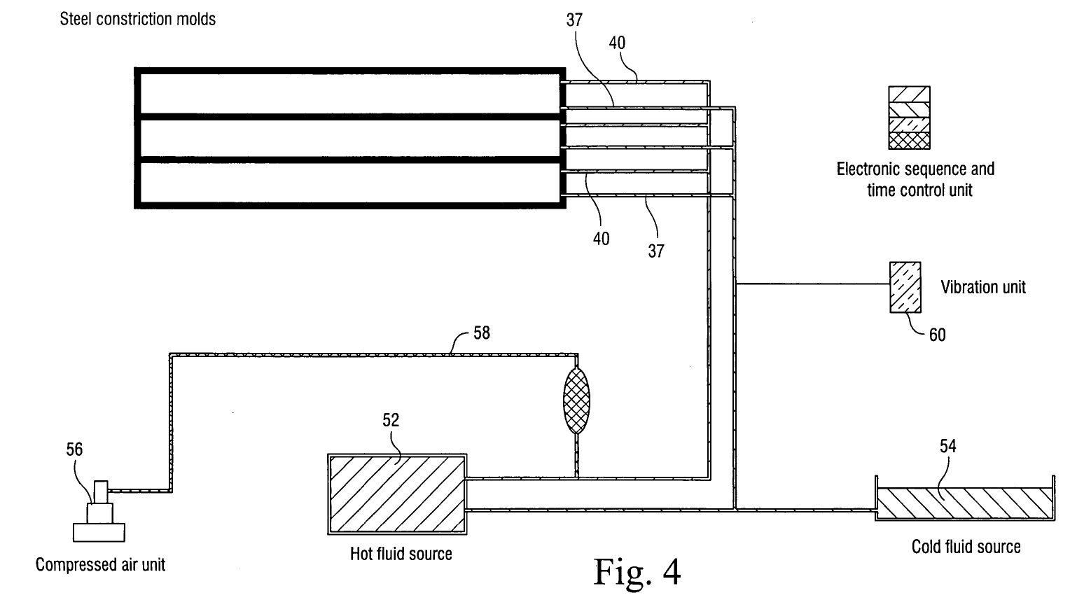

Referring now to FIG. 3, a plurality of male molds generally indicated 28 are utilized in the fabrication of the panel. Each male mold includes a preferably cylindrical tubular steel or aluminum body 30 which extends longitudinally approximately the length of the panel but terminating in a closed end 31 short of the length of the panel. At the opposite end, a pair of end plates 32 and 34 form a chamber 36. A side wall 44 of the first or steel mold includes a plurality of openings to accommodate an extension 38 of the aluminum or steel male mold 28. The tube 30 includes an inlet 40 for flowing a fluid into the volume 42 downstream of the chamber 36 and an outlet 37 in communication with the chamber 36. The tube 30 has an overlying flexible and/or resilient cover preferably formed of flexible rubber 46 extending the full length of the tube 30. Apertures 48 near the closed end of tube 30 lie in communication with the interior of the flexible cover 46. Apertures 50 are also formed in the tube 30 communicating between chamber 36 and the interior surface of the cover. The end of the tube adjacent the mold openings forms a tight fit and a seal may be provided. A typical wall panel of average width of about 120 cm. requires about fifteen molds 28 with diameters of about 50 mm.

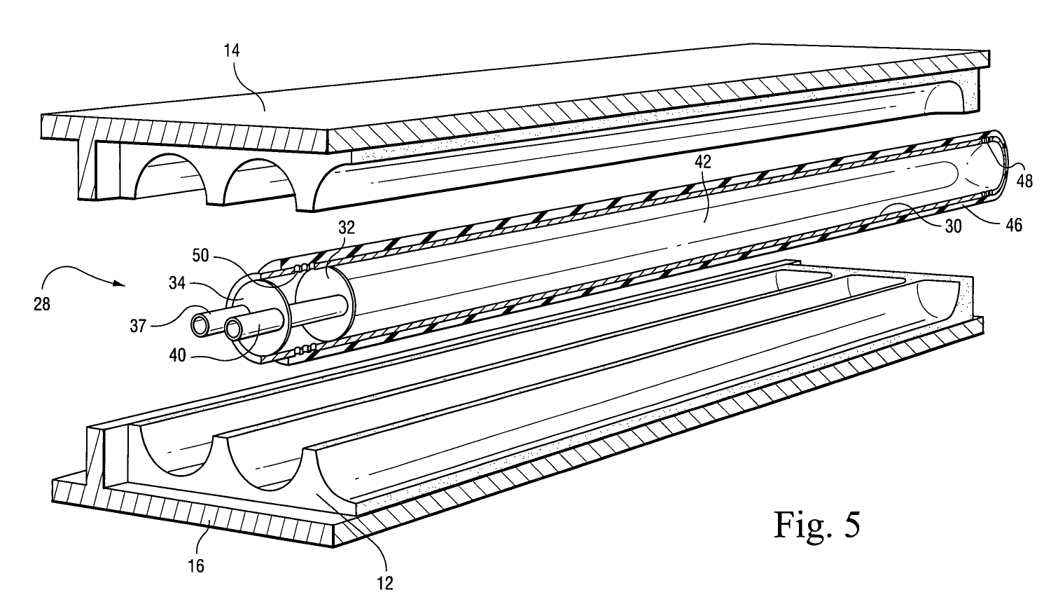

Referring to FIG. 4, a plurality of superposed molds are illustrated with the fluid inlet and outlet tubes 40 and 37 for each mold. The fluid inlet tube 40 is coupled to a source of heated fluid 52 while the outlet tube 37 is coupled to a source of fluid at a colder or reduced temperature 54. The fluid inlet line 40 is coupled to a compressed air unit 56 via line 58. Additionally, a vibration unit 60 for vibrating the fluids applied to the male molds is illustrated.

To form these panels and referring particularly to FIGS. 6A-6H, the uncovered bottom and side molds 16 and 18 receive a first layer of first material 22. A mesh material for example material 20 is then laid over the first layer 22 as illustrated in FIG. 6B In FIG. 6C, a first layer of a filler material 26a is applied overlying mesh material 20. The male molds 28 are also inserted through apertures in the side wall of the mold to overlie the mesh material 20 and filler material 26a. In FIG. 6D, a second layer of filler material 26b is disposed in overlying relation to the male molds and the first layer of filler material 26. In FIG. 6E, a second layer of mesh material 20 overlies the second layer of filling material 26b. Finally in FIG. 6F, the final or second layer of a second material 24 is applied over the mesh material 20. In FIG. 6G, the cover 14 for the mold is applied and molds may be stacked one on top of the other as illustrated. Preferably the various materials, i.e., the first and second filler materials may be sprayed into the molds.

Once the steel molds are sealed, pressurized and heated liquid is applied to the male molds 28. Thus, heated liquid from source 52 is pumped into the interior of the male mold tube 30 and exits via apertures 48 into the volume between the outer surface of tube 30 and the interior surface of the flexible cover 46. The flexible cover thus expands creating a volume between the rigid tube and the flexible cover and pressurizes the material within the mold increasing its diameter in a typical panel to about 75 mm. This effectively distributes the filling material by squeezing out any and all gaps in between the mold material and the surfaces of the steel molds. Upon reaching sufficient pressurization, the vibration unit 60 is applied to the liquid so that the combined pressure and vibration is applied to the filler materials. After attaining a prescribed temperature to cure the filler material, which temperature may vary depending upon the filling material utilized, and the desired hardness, a cold liquid from source 54 is applied to the system. Thus, the liquid from source 54 may be supplied to the extension tube 37 for flow through apertures 50 into the volume between the flexible cover and the rigid tube displacing the heated liquid through apertures 48 and through extension tube 40 for return to the fluid source. Introduction of the cold liquid facilitates the curing process. The system is then depressurized by removing the fluid from the volume between the cover and the rigid tube as well as from the male molds, thereby returning the individual molds 28 to their approximate original diameter, e.g., about 50 mm. It will be appreciated that the pressurized heating water or oil and the cooling liquid are applied to inflate the flexible cover about the rigid tube 30 and that the flexibility and adjustability of the cover maintains a specified diameter through pressurization as well as the uniform distribution of the filling material and the elimination of bubbles and gaps that may form between the layers. The flexibility and adjustability of the rubber cover also compensates for any minor errors in the amount of filling material utilized.

During the pressurization, vibration and curing process, the molds are rotated horizontally to allow any air bubbles that may have been formed on the surfaces, i.e. trapped between the wall panel surfaces and the mold plates to be absorbed back into the filler materials. After the panels have been cooled down and sufficient curing has occurred, the stacked mold system may be unstacked and male molds removed. Thus, the mold holes come into contact with open air for the purpose of continuing the curing process until curing ends during storage of the fabricated panels.

It will be appreciated that during the foregoing described fabrication process the pressurization, vibration, temperature and cooling phases are separate from and independent of each other. Consequently it is possible to make immediate and independent adjustments as required in any of these four phases of the production.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of fabricating panels for use in a building comprising the steps of:
(a) providing a first mold having a bottom wall and side walls;
(b) disposing a first layer of a first material within the first mold;
(c) disposing a first layer of mesh material overlying the first layer of material;
(d) disposing a first layer of filler material overlying the first layer of mesh material;
(e) locating a plurality of male molds at spaced locations from one another within the first mold and overlying the first layer of filler material.
(f) disposing a second layer of a filler material within the first mold about said male molds and overlying the first layer of filler material;
(g) disposing a second layer of mesh material overlying the second layer of filler material;
(h) disposing a second layer of a second material within the first mold and overlying the second layer of mesh material;
(i) closing the first mold;
(j) expanding the male molds within the closed first mold to pressurize the first, second and filler materials;
(k) removing the male molds from the first mold; and
(l) removing the panels from the first mold; and
(m) curing the first, second and filler materials.

2. A method according to claim 1 wherein step (g) includes flowing a fluid into the male molds to expand the male molds.

3. A method according to claim 1 including flowing a fluid at an elevated temperature into the male molds to provide a heat exchange relation between said fluid and said first, second and filler materials in said closed first mold to facilitate hardening of the materials.

4. A method according to claim 1 including providing each male mold with a flexible cover about a rigid tube and step (j) includes flowing a fluid into the rigid tube and through apertures therethrough into a volume between the rigid tube and the flexible cover to expand the cover relative to the tube within the first mold.

5. A method according to claim 4 including providing a chamber within the rigid tube in communication with said volume for receiving fluid exiting therefrom.

6. A method according to claim 1 including flowing a fluid at an elevated temperature into the male molds to provide a heat exchange relation between said fluid and said first, second and filler materials in said closed first mold to facilitate hardening of the materials, and vibrating the fluid within the male molds to vibrate the materials within the first mold.

7. A method according to claim 1 including flowing a fluid at an elevated temperature into the male molds to provide a heat exchange relation between said fluid and said first, second and filler materials in said closed first mold to facilitate hardening of the materials, and subsequent to flowing the fluid at elevated temperature, flowing a cooling fluid into the male molds to cool the materials.

8. A method according to claim 1 including, after step (j) and prior to step (k), contracting the male molds to reduce their size within the first mold and the panel.

9. A method according to claim 1 including rotating the closed first mold to substantially preclude formation of air bubbles at the panel surfaces in contact with mold surfaces of said first mold.

10. A method according to claim 1 including providing said first, second and filler materials from at least one of agricultural or industrial waste materials.

11. A method according to claim 1 including providing at least two of the first, second and filler materials in mixtures having different particle sizes.

12. A method of fabricating panels for use in a building comprising the steps of:
(a) providing a plurality of molds, each having a bottom wall and side walls;
(b) disposing a first layer of a first material within each mold;
(c) disposing a first layer of mesh material overlying the first layer of material in each mold;
(d) disposing a first layer of filler material overlying the first layer of mesh material in each mold;
(e) locating a plurality of male molds at spaced locations from one another within each mold and overlying the first layer of filler material;
(f) disposing a second layer of a filler material within each mold about said male molds and overlying the first layer of filler material;
(g) disposing a second layer of mesh material overlying the second layer of filler material in each mold;
(h) disposing a second layer of a second material within each mold and overlying the second layer of mesh material;
(i) closing each mold;
(j) stacking the plurality of molds one on top of another;
(k) expanding the male molds within the stacked molds to pressurize the first, second and filler materials in each mold to form the panels in the molds;
(l) removing the male molds from each mold;
(m) removing the panels from each mold; and
(n) curing the first, second and filler materials within each mold.

13. A method according to claim 12 wherein step (k) includes flowing a fluid into the male molds to expand the male molds and subsequently contracting the male molds to reduce their size within each mold and panel.

14. A method according to claim 12 including providing each male mold with a flexible cover about a rigid tube and step (k) includes flowing a fluid into the rigid tube and through apertures therethrough into a volume between the rigid tube and the flexible cover to expand the cover relative to the tube within the first mold.

15. A method according to claim 12 including rotating the closed molds to substantially preclude formation of air bubbles at the panel surfaces in contact with surfaces of the molds.

16. A method according to claim 13 including providing said first, second and filler materials from at least one of agricultural or industrial waste materials.

17. Mold apparatus for forming building panels comprising:
a first mold having a bottom, sides and a removable top cover defining a mold volume; and
a plurality of elongated male molds for disposition within the mold volume and spaced one from the other;
each said male mold including an elongated rigid tube and an overlying flexible cover, said tube including a fluid inlet for flowing fluid into and within the tube and at least one aperture in communication with a second volume between the cover and tube for flowing fluid from within said tube through said aperture, said tube including an outlet in communication with said second volume for flowing fluid therefrom through said outlet.

18. Apparatus according to claim 19 wherein said rigid tube includes a chamber within the confines of said tube, said outlet lying in communication with said chamber enabling fluid to exit the male mold.
